(19) United States
(12) Patent Application Publication
(10) Pub. No.: US 2009/0061829 A1
(43) Pub. Date: Mar. 5, 2009

(54) SYSTEM AND METHOD FOR MEDIA SELECTION

(75) Inventor: John M. Harris, Glenview, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/846,626

(22) Filed: Aug. 29, 2007

(51) Int. Cl. H04Q 7/20; H04M 1/00

(52) U.S. Cl. 455/414.1; 455/566

(57) ABSTRACT

At a mobile station (102), an indication (111, 114, 116, 118) is received of at least one ambient condition. Based at least in part upon the indication of the at least one ambient condition, a media selection is determined. The media selection is then presented to a user at the mobile station (102).

### FIELD OF THE INVENTION

The field of the invention relates to the media presented to users at mobile stations and, more specifically, to selecting this media.

### BACKGROUND OF THE INVENTION

Different types of media can be presented to users of today's telecommunication systems. For example, songs, video presentations, video games, audio segments, and other types of media may be presented to users. For the convenience and enjoyment of users, the media can be presented at the mobile station of the user such as at the user's cellular telephone, pager, gaming device, personal digital assistant, personal computer, etc.

The media, when being viewed or otherwise utilized by a user, can be interrupted by different types of events. Some of these events are predictable. For example, scheduled calendar events, scheduled broadcasts, and exceeding a time limit are events that are, to a large extent, predictable and foreseeable. On the other hand, other types of events are far less predictable. For example, mobile station handoffs or the mobile station entering or exiting coverage areas are examples of events that can be predicted with less certainty.

Regardless of the type of interruption, frequent or untimely interruptions during media presentations reduce the quality of the user experience at the mobile station. Previous attempts at preventing or minimizing the impact of interruptions during media presentations have generally been inconvenient to implement and/or ineffective. For example, in some previous systems, users created lists that prioritized the distribution of media, such as movies. However, it was often time-consuming to create the lists. Additionally, these approaches often proved inadequate in avoiding interruptions.

In other previous approaches, complicated arrangements were used to tabulate media preferences of users and then route media to users based upon these preferences. Unfortunately, these systems were also complicated and costly to implement. Additionally, these systems often did not avoid or minimize the impact of interruptions.

Furthermore, in today's networks, mobile stations typically move and/or conditions associated with the mobile station often change. As conditions change, the user may desire that different media be presented. For example, when a user is walking, they may want to listen to a first song or first type of music. In another example, when the user is running or exercising, the user may wish to listen to a second song or type of music. In still another example, when the user is sitting or resting, they may wish to view a movie. Previous systems have required that the user manually change the media when conditions change. The necessity of manually changing the media presentation for every condition change has further degraded the user experience with these systems. Consequently, user frustration with these previous systems has also increased.

### BRIEF DESCRIPTION OF THE DRAWINGS

The above needs are at least partially met through provision of a system and method for media selection described in the following description, particularly when studied in conjunction with the drawings, wherein:

FIG. 1 is block diagram of system for determining media selections according to various embodiments the present invention;

FIG. 2 comprises a flowchart of an approach for making media selections according to various embodiments of the present invention;

FIG. 3 comprises a flowchart of an approach for making media selections according to various embodiments of the present invention; and

FIG. 4 comprises a block diagram of a device that determines media selections according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF EMBODIMENTS

A system and method are provided that automatically present suitable media to users. In some of these approaches, the media selection is automatically optimized so as to minimize the impact and number of interruptions that may potentially occur during the presentation of the media to the user. In others of these approaches, media selections are automatically determined based upon a condition, need, or preference of the user or the system. These approaches are cost effective to implement, enhance the user experience with the system, and significantly reduce or eliminate user frustration with the system.

In many of these embodiments, at a mobile station, an indication is received of one or more ambient conditions. The ambient conditions may include a wide variety of conditions or characteristics that do not directly indicate a media selection such as the heart rate of the user, weather conditions, the time of day, the anticipated time of a communication handoff, the physical position of the user, the location of the user, the location of a user relative to a preferred vendor, the route of a user, the battery life of a battery at the mobile station, a scheduled calendar broadcast, a presence update, the availability of another user, a meeting notification, or a change in service for the mobile station. Other examples of ambient conditions are possible.

Based at least in part upon the indication of the ambient condition, a media selection is determined. The media selection is then presented to a user at the mobile station.

In others of these embodiments, a current media selection is presented to the user. The mobile station then determines the next media selection and this next media selection may be presented to the user at the conclusion of the presentation of the current media selection.

In still others of these embodiments, one or more characteristics of the media selection can be chosen based upon the ambient condition. The one or more characteristics can be selected from a wide variety of characteristics such as the playing length of the media selection, the genre of the media selection, an indicated user preference, or the order of presentation of portions of the media selection. Other examples of characteristics or combinations of characteristics are possible.

The media selection may also be synchronized with the occurrence of an event. The event may take many forms. For example, the event may an email synchronization event or a presence synchronization event. In the case of an email synchronization event, the media presentation may be selected so as to finish just before an email download is received from a network.

In some of these embodiments, the selection process may determine more than one media selection to be presented to the user at the mobile station. For example, different media selections can be determined and presented to the user at various locations along a travel route of the user. In another example, multiple songs of the same genre can be selected and sequentially played for the user.

Thus, approaches are provided that automatically present suitable media to users. These approaches minimize and/or avoid the problems associated with interruptions that may occur during media presentations. For instance, interruptions may be less desirable during the playback of longer length media (as opposed to shorter length media) since the user has invested more time and effort into viewing the longer length media (as opposed to a shorter length media).

Additionally, the approaches provided herein select media that are appropriate based upon the condition, needs, or preferences of the user, the mobile station, other users, or the network. Furthermore, these approaches enhance the user experience and significantly reduce or eliminate user frustration with the system.

Although the examples described herein are described as presenting the media to users at mobile stations, it will be appreciated that these approaches may also be used to present media to users at other locations as well. For example, the approaches described herein can be used to present media to users at fixed locations (e.g., televisions in their homes) or other locations. Additionally, although the present approaches are described as having the mobile station make the media selection determination, it will be appreciated that these approaches can be implemented at any network element or device or combination of elements or devices.

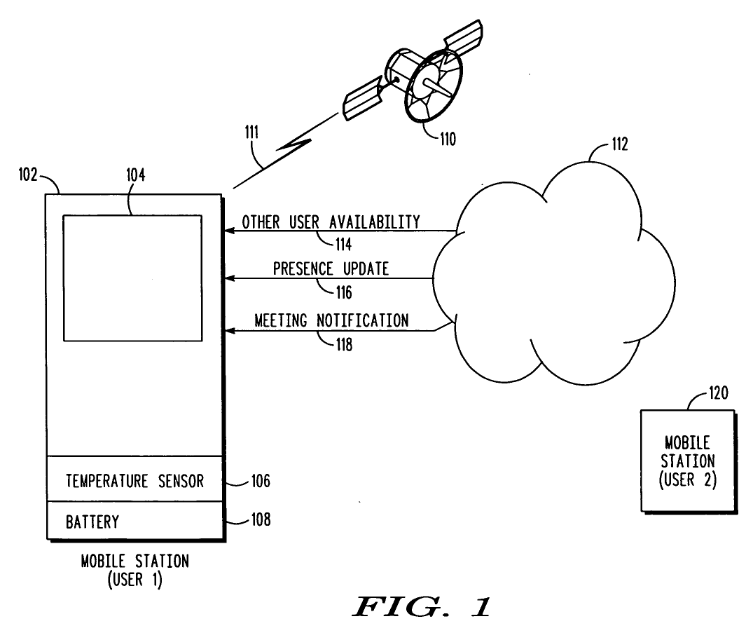

Referring now to FIG. 1, a system for determining media selections is described. A first mobile station 102 includes a display 104, a temperature sensor 106, and a battery 108. A satellite system 110 sends signals 111 to the first mobile station 102. The first mobile station 102 uses the signals 111 to determine its location.

As mentioned, the first mobile station 102 includes the display 104, which, in one example, is a liquid crystal display (LCD). In addition, the first mobile station 102 may include other types of presentation mechanisms such as speakers, light emitting diodes (LEDs), or other types of presentation devices.

Along with the first mobile station 102, a second mobile station 120 is communicatively coupled to a communication network 112. The second mobile station 120 may be a buddy, friend, or have some other predetermined relationship with the first mobile station 102.

The first mobile station 102 and the second mobile station 120 may be any type of mobile communication device. For example, the first mobile station 102 and the second mobile station 120 may be cellular phones, personal digital assistants, pagers, or personal computers. Other examples of mobile stations are possible. In addition, additional mobile stations may operate in conjunction with the network 112.

The network 112 may be any type of network or combination of networks. For example, the network 112 may be a cellular network, a wireless local area network (WLAN), the Internet, or a combination of these networks. Other types of networks or combinations of networks are possible.

The network 112 transmits various types of indicators to the first mobile station 102. Specifically, the network transmits other user availability data 114, which indicates the availability of other users, for example, a user operating the second mobile station 120. The network 112 also sends presence update data 116, which indicates the availability, location, and/or other characteristics of other users, for example, the user operating the second mobile station 120. Furthermore, the network 112 sends meeting notification data 118 to notify the user at the mobile station 102 of upcoming meetings or events that the user is scheduled to attend. Alternatively, the meeting notification data 118 may include meeting information concerning other users, for example, the user at the second mobile station 120.

In one example of the operation of the system of FIG. 1, an indication of at least one ambient condition is received at the first mobile station 102. The ambient condition does not directly indicate a media selection, but is a condition that itself is further evaluated in order to determine the media selection. In some examples, the ambient condition may be the position of the mobile station (as indicated by the signals 111); the temperature sensed by the temperature sensor 106, the battery life of the battery 108, the availability of other users (as indicated by the other user availability data 114), the presence of other users (as indicated by the presence update data 116), the time or date of a meeting (as indicated by the meeting notification data 118), or some combination of these indicators.

Other types of ambient conditions may be received and evaluated by the mobile station 102 to determine the media to present to the user. For example, the heart rate of the user, other types of weather conditions, the time of day, the anticipated time of a communication handoff, the physical position of the user (e.g., sitting, walking, or running), the location of a user relative to a preferred vendor, the route of a user, a scheduled calendar broadcast, or a change in service for the mobile station 102 may also be used. Furthermore, the movement of the user, the amount of memory used at the first mobile station 102, historical call statistics, stock indices, the user's personal characteristics (e.g., when the user last ate, smoked, or exercised) can also be used as the ambient characteristics.

Based upon the indication of the one or more ambient conditions, the media selection is determined. The media selection is then presented to a user at the mobile station 102 via the display 104. A current media selection may already be in the process of being presented to the user at the display 104. The media selection determined may then be presented to the user at a conclusion of the presentation of the current media selection.

The media can include videos (e.g., movies or television programming), videogames, songs, the order in which these things are presented, voice mail messages, or emails. Other examples of media are possible.

In addition, the selection process may determine more than one media selections that are to be presented to the user. For example, more than one media selection can be determined and presented to the user at various locations along the travel route of the user.

Various characteristics of the media that is to be presented to the user at the mobile station 102 may also be determined. For example, the type or genre of media (e.g., movie, song, video game) to present to the user may be determined. The length of the play out of the media may also be determined. When multiple media selections are used, the order of presentation of portions of the media selection may be determined. Other characteristics may also be chosen.

The actual media selection can be made using the ambient conditions in any number of ways. For instance, if battery life is used, a shorter media presentation may be selected when battery life is low. In another example, a longer length media selection may be made when a longer battery life is available.

If user location is the condition, a different media (e.g., a different song) may be played to get the user to pay attention for a particular sign (e.g., a stop sign or an exit sign) at certain locations along a travel route. In another example, a business may pay to have an advertisement presented to the user when the user is near the business. In this case, the advertisement may be presented to the user as the user walks past the business. In so doing, it is more likely the user will purchase something from the business. In still another example, an advertiser could influence the user to choose a particular media (e.g., choose a song having a particular mood) where the chosen media tends to influence the user to purchase a specific product. In yet another example, an advertiser or store owner pays to influence the media selection, for instance, to influence the user to select a media that would complete as the user passes a store. In this case, since the media would complete as the store is passed, it would be more likely that the user would enter the store.

In other examples, it may be desirable to time the media presentation to end at a certain point in time. For example, the media presentation may be timed to end upon the arrival of a user at a location that has no communication resources.

As mentioned, although in the present examples the media determination is made at the mobile station 102, it will be appreciated that the determination may be made at or in combination with other network elements. For example, the network 112 may determine the media to be presented at the mobile station. Furthermore, the media may be stored at the first mobile station 102 or transmitted to the mobile station 102 from another source (e.g., the network 112).

The media selection may also be synchronized with the occurrence of other events and these events may take many forms. For example, the event may include email synchronization events (e.g., synchronization messages from the network 112) and presence synchronization events (e.g., synchronization messages from the network 112). In one example, downloaded emails can be received at the end of the media presentation rather than during the media presentation.

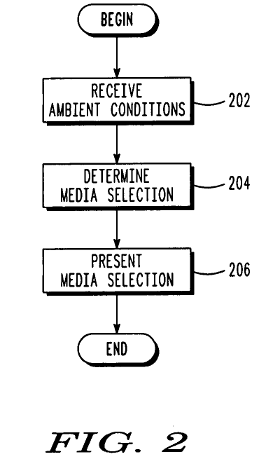

Referring now to FIG. 2, an approach for determining media selections is described. At step 202, ambient conditions are received at the mobile station. For example, these conditions may include the heart rate of the user, weather conditions, the time of day, the anticipated time of a communication handoff, the physical position of the user, the location of the user, the location of a user relative to a preferred vendor, the route of a user, the battery life of a battery at the mobile station, a scheduled calendar broadcast, a presence update, the availability of another user, a meeting notification, or a change in service for the mobile station.

At step 204, a media selection is determined. For example, based upon the ambient conditions received at step 202 a media selection may be determined to avoid interruptions. In another example, the media selection may be made so as to conform to the conditions or preferences of the user.

At step 206, the media that has been selected according to the condition is presented to the user. The presentation may be made based upon the type of media. For example, a display screen may be used to present video media and a speaker may be used to present audio media.

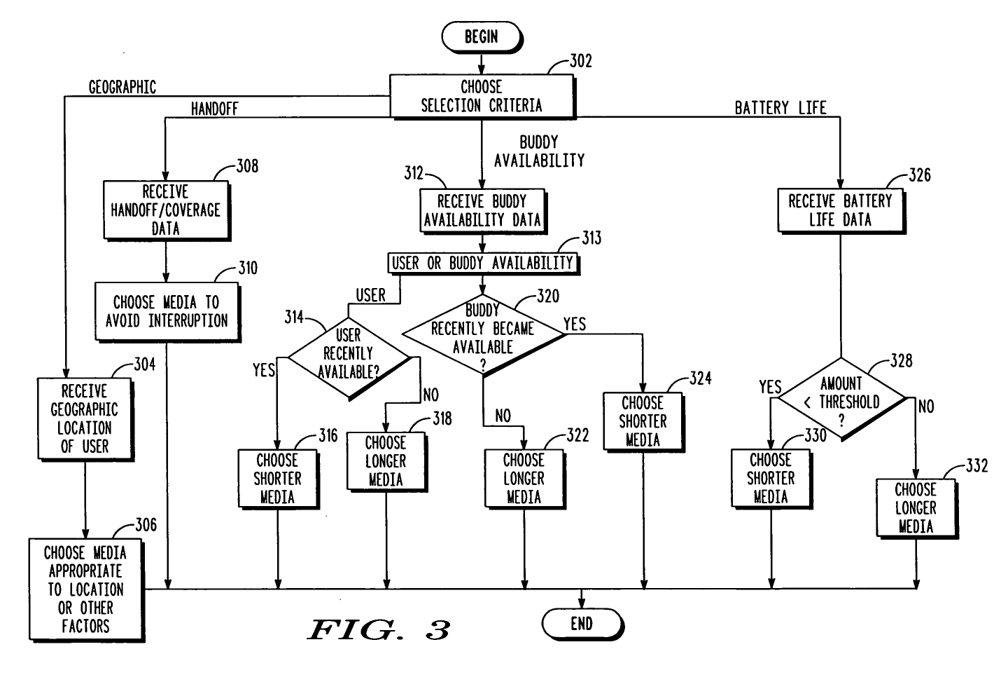

Referring now to FIG. 3, an approach for determining media selections to be presented to a user at a mobile station is described. At step 302, one or more selection criteria are determined and used to select media that is to be presented to the user. Based upon the particular selection, a particular path and sequence of steps is executed. In the example of FIG. 3, the criteria that are used to select the media to be presented to the user include the geographic location of the user, handoff data, buddy availability, and/or the battery life of the battery powering the mobile station.

If the geographic location of the user is chosen to determine the media selection, then at step 304 geographic location information is received and/or determined. In one example, the information is determined at and received from an outside source such as a computer network. In another example, the mobile station directly determines its location based upon signals from other sources (e.g., received signal strength signals from beacons or satellite signals).

At step 306, an appropriate media selection may be made based upon the location of the mobile station and/or other factors. For example, a certain media may be presented to the user at their mobile station when the mobile station is near a particular business or vendor. In other examples, additional factors, such as user movement, may be used. For instance, if the user is exercising, a particular media selection may be presented to the user. On the other hand, if the user is sitting, another type of media may be presented to the user.

If handoff data is to be used to make the media selection, then at step 308, handoff and/or coverage data is received. This data may indicate, for example, when a handoff is likely to occur, for example, when the user is at the edge of a coverage area. This data may also indicate when a seamless transition is likely to occur (e.g., going into range of an area where a different/preferred user device is located). For example, when the user gets home, the user normally switches to using a home speaker system instead of the speaker phone on the cellular phone of the user. The data may also be useful in determining an estimate as to when a handoff would occur, for example, given the history and movement of the mobile station.

At step 310, appropriate media is selected so as to avoid an interruption because of a handoff. For example, a longer length media may be selected when it is deemed that a handoff/change in coverage area is not likely. On the other hand, a shorter length media may be selected when it is deemed that a handoff/change in coverage area is more likely or is likely to occur in the near future.

If buddy availability is to be used to determine media selection, then at step 312, buddy availability data is received. This information may include whether a buddy is available, how long the buddy has been available, the activity engaged in by the buddy, and/or the operational status of the buddy. Other types of information relating to the buddy may also be received.

At step 313, it is determined if the decision as to media selection is to be further based upon whether the user or the buddy has become more recently available. If the determination is to be based upon the user becoming more recently available, the series of steps beginning with step 314 is followed. If the determination is to be based upon how recently the buddy has become available, the series of steps beginning with step 320 is followed.

At step 314, it is determined if the user (user X) has recently become available. For example, a time threshold may be compared against the data received at step 312. If the answer at step 314 is affirmative, then at step 316 a shorter length media is selected. The shorter length media is selected because if the user has become available more recently, the chances are that the buddy of user X is more likely to contact (and interrupt) the user X.

On the other hand, if the answer at step 314 is negative, then at step 318 a longer length media is selected. The longer length media is selected since it is deemed more probable that the chance of interruption from the buddy is less if user X has been available longer (e.g., user X is deemed to be more desirable if he or she has been on the market for a longer period of time).

At step 320, it is determined if the buddy of user X has recently become available. For example, a time threshold may be compared against the data received at step 312. If the answer at step 320 is affirmative, then at step 324 a shorter length media is selected. The shorter length media is selected because if the buddy of user X has become available more recently, the chances are that user X is more likely to want to contact the buddy (and interrupt) the current media.

On the other hand, if the answer at step 320 is negative, then at step 322 a longer length media is selected. The longer length media is selected since it is deemed more probable that the chance of user X interrupting the current media in order to call the buddy of user X is less if the buddy has been available longer.

If battery life is to be used to determine the media selection, then at step 326, battery life data is received. For example, this information may indicate the energy level of the battery. At step 328, it is determined if this amount is less than a predetermined threshold. If the answer at step 330 is affirmative, then at step 332 a relatively short media is selected. In selecting a shorter length media, the chances of any interruption (e.g., the running out of battery power midway through a long media playback) are reduced. If the answer at step 322 is negative, then at step 326 a longer length media is chosen. In this situation, there is a relatively low chance of an interruption (e.g., the battery running out of power).

It will be appreciated that other types of ambient condition can be used to determine media selections or characteristics of these selections and other algorithms or approaches can be used to make the media selection. Further, it will be realized that the multiple conditions can be used to determine the media selection. For example, to use the example of FIG. 3, both the battery life and the geographic location of the user may be used to make a media selection.

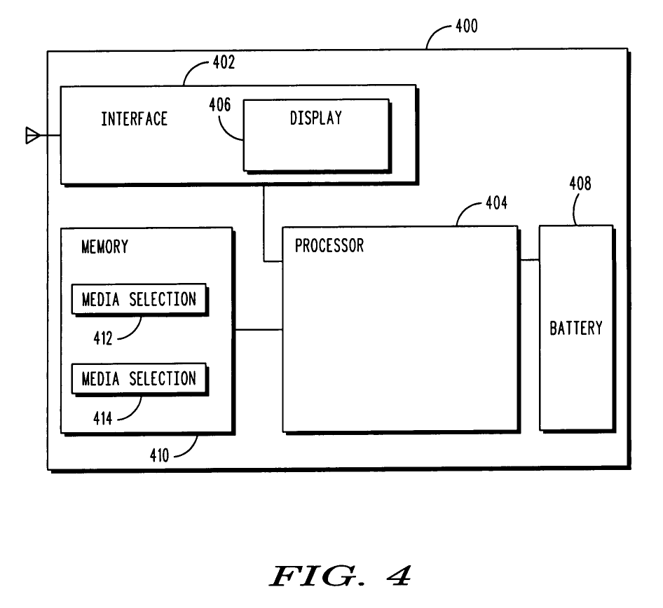

Referring now to FIG. 4, a device for determining media selections is described. The device includes an interface 402 (including a display 406), a processor 404, a battery 408, and a memory 410. The memory 410 stores a first media selection 412 and a second media selection 414.

The interface 402 is adapted and configured to receive one or more ambient conditions. For example, the ambient condition may relate to the heart rate of the user, weather conditions, the time of day, the anticipated time of a communication handoff, the physical position of the user, the location of the user, the location of a user relative to a preferred vendor, the route of a user, the battery life of a battery 408, a scheduled calendar broadcast, a presence update, the availability of another user, a meeting notification, or a change in service for the device.

The processor 404 is adapted and configured to determine a media selection (the first media selection 410 and/or the second media selection 412) based upon the received ambient condition(s) and to present the media selection to a user at the display 406 of the interface 402. The processor 404 may be further adapted and configured to synchronize the presentation of the media selection with an occurrence of an event. The event may be any number of events such as email synchronization events and presence synchronization events. Other examples of events are possible. In one example, a movie may be selected so that the presentation of the movie is finished just before a scheduled email download occurs from a network.

Thus, approaches are provided that automatically select and present suitable media to users. These approaches minimize the number and effect of interruptions on the user and the system. Additionally, approaches are described where appropriate media selections are presented to users based upon the condition, need, or preference of the user, the mobile station, the network, or other users. These approaches enhance the user experience with the system and significantly reduce or eliminate user frustration with the system.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method for choosing media selections comprising:
at a mobile station:
receiving an indication of at least one ambient condition;
based at least in part upon the indication of the at least one ambient condition, determining a media selection; and
presenting the media selection to a user at the mobile station.

2. The method of claim 1 further comprising presenting a current media selection to the user; wherein determining a media selection comprises determining a next media selection; and wherein presenting the media selection comprises presenting the next media selection to the user at a conclusion of presenting the current media selection.

3. The method of claim 1 wherein determining a media selection comprises determining a type of media to present to the user.

4. The method of claim 1 wherein the at least one ambient condition is selected from a group comprising: a heart rate of the user; a weather condition; a time of day; an anticipated time of a communication handoff; a physical position of the user; a location of the user; a location of a user relative to a preferred vendor; a route of a user; a battery life of a battery at the mobile station; a scheduled calendar broadcast; a presence update; an availability of another user; a meeting notification; and a change in service for the mobile station.

5. The method of claim 1 further comprising choosing at least one characteristic of the media selection based at least in part upon the at least one ambient condition.

6. The method of claim 5 wherein the at least one characteristic is selected from a group comprising: a playing length of the media selection, a genre of media selection, a user preference information, and an order of presentation of portions of the media selection.

7. The method of claim 1 wherein presenting the media selection is synchronized with an occurrence of an event.

8. The method of claim 7 wherein the event is chosen from a group comprising: an email synchronization event and a presence synchronization event.

9. The method of claim 1 wherein determining a media selection comprises determining a plurality of media selection choices and presenting the plurality of media selection choices to the user.

10. A method for choosing media selections comprising:
at a mobile station:
presenting a current media selection to a user at the mobile station;
receiving an indication of a future occurrence of an interruptive event;
determining a next media selection based at least in part upon the indication, a length of the next media selection being chosen so as to allow a complete presentation of the next media selection to the user before the future occurrence of the interruptive event; and
at a conclusion of presenting the current media selection, presenting the next media selection to the user at the mobile station.

11. The method of claim 10 wherein the interruptive event is selected from a group comprising: a weather condition; a time of day; an anticipated time of a communication handoff; an anticipated battery expiration for a battery of the mobile station; a scheduled calendar broadcast; a presence update; an availability of another user; a meeting notification; and a change in service for the mobile station.

12. The method of claim 10 further comprising determining a travel route for the user based upon the indication.

13. The method of claim 10 wherein presenting the next media selection is synchronized with an occurrence of an event.

14. The method of claim 13 wherein the event is chosen from a group comprising: an email synchronization event and a presence synchronization event.

15. A device comprising:
an interface adapted and configured to receive at least one ambient condition, the interface including a display; and
a processor coupled to the interface, the processor being adapted and configured to determine a media selection based at least in part upon the ambient condition and to present the media selection to a user at the display of the interface.

16. The device of claim 15 wherein the at least one ambient condition is selected from a group comprising: a heart rate of the user; a weather condition; a time of day; an anticipated time of a communication handoff; a physical position of the user; a location of the user; a location of a user relative to a preferred vendor; a route of a user; a battery life of a battery; a scheduled calendar broadcast; a presence update; an availability of another user; a meeting notification; and a change in service for the device.

17. The device of claim 15 wherein the processor is further adapted and configured to synchronize presentation of the media selection with an occurrence of an event.

18. The device of claim 17 wherein the event is chosen from a group comprising: an email synchronization event and a presence synchronization event.
